(19) United States
(12) Patent Application Publication
(10) Pub. No.: US 2021/0231143 A1
(43) Pub. Date: Jul. 29, 2021

(54) DEVICE AND METHOD FOR AUGMENTING GAS FLOW

(71) Applicant: Jonathan Jan, Culver CIty, CA (US)

(72) Inventor: Jonathan Jan, Culver CIty, CA (US)

(21) Appl. No.: 17/230,305

(22) Filed: Apr. 14, 2021

Related U.S. Application Data
(63) Continuation-in-part of application No. 16/682,524, filed on Nov. 13, 2019, now Pat. No. 11,009,052.
(60) Provisional application No. 62/850,255, filed on May 20, 2019.

(51) Int. Cl. F15D 1/02

(52) U.S. Cl. CPC F15D 1/025

(57) ABSTRACT

A device to augment gas flow so an exit gas flow will have a higher exit velocity than an inlet gas flow has an inner structure having a first open end and a second open end. The inner structure is hollow. The inner structure tapers down from both the first open end and the second open end to a neck area. At least one opening is formed in the neck area. An outer structure has a first open end and a second open end. The outer structure is hollow. A diameter of the first open end of the outer structure and the second open end of the outer structure are approximately equal and allow the inner structure to slide within the outer structure. At least one outer structure opening is formed in a central area of the outer structure. A housing is attached to the at least one outer structure directing gas flow from a propulsion device within the housing into the device.

### RELATED APPLICATIONS

This patent application is a Continuation-In-Part of U.S. patent application Ser. No. 16/682,524, filed Nov. 13, 2019, entitled “DEVICE AND METHOD FOR AUGMENTING AIR MASS FLOW” which is further related to U.S. Provisional Application No. 62/850,255 filed May 20, 2019, entitled “DEVICE AND METHOD FOR AUGMENTING AIR MASS FLOW” both in the name of Jonathan Jan, and which is incorporated herein by reference in its entirety. The present patent application claims the benefit under 35 U.S.C § 119(e).

### TECHNICAL FIELD

The present application generally relates to renewable energy sources, and, more particularly, to a device that is able to augment gas flow so that an exit gas flow will have a higher exit velocity and hence a higher kinetic energy than an inlet gas flow.

### BACKGROUND

Renewable energy may be defined as energy produced from sources that do not deplete or can be replenished within a human's life time. The most common examples of renewable energies include wind, solar, geothermal, biomass and hydropower. In an effort to reduce greenhouse gases, there has been an increase demand for the use of renewable energy sources. Using renewable energy can reduce the use of fossil fuels, which are major sources of carbon dioxide emissions.

While renewable energy systems are better for the environment and produce less emissions than conventional energy sources, many of theses sources still face difficulties in being deployed at a large scale. Some of the reasons for these difficulties include, but are not limited to, technological barriers, high start-up capital cost and intermittency challenges.

Wind energy may be defined as the means of harnessing wind and turning it into electricity. Wind mills/turbines take advantage of the kinetic energy or “motion energy” that moves air or wind from one place to another and converts it to electricity. Wind turbines are erected in windy places, so the wind can move the blades of the turbines. These blades rotate a motor, and gears increase the rotations enough to produce electricity. Unfortunately, wind energy has several intrinsic flaws as will be discussed below.

First, wind turbines have wind efficiencies that are problematic. Wind efficiency may be defined as the amount of kinetic energy in the wind that is converted to mechanical energy and electricity. The laws of physics described by Betz Limit describe the maximum theoretical limit for the amount of kinetic energy in the wind that may be converted to mechanical energy is around 59.6%. Unfortunately, it is not possible for any machine, at present to convert all of the trapped 59.6% of kinetic energy from wind to electricity. There are limits due to the way generators are made and engineered, which further decrease the amount of energy that is finally converted to power. Presently, wind efficiency of most wind turbines is around 20-35%.

Second, wind capacity factors may be defined as the amount of energy produced by a wind turbine as against what it could produce if the wind turbine functioned all the time at peak capacity. Wind capacity factors tend to vary from place to place and is differs during different times of the year, even with the same turbines. Unfortunately, wind speeds are unpredictable and not constant, causing wind turbines to have lower than expected wind capacity factors. While, in the past, the wind capacity factors of wind turbines were around 20-30%, recent technological improvements have raised this number to closer to 50%. However, even with these improvements, wind energy is still not well suited as a base load energy source.

Third, while wind energy is supposed to be better for the environment, wind turbines still pose environmental concerns. The key mechanical and power-generating elements in a wind turbine are a gearbox and the generator to which it is attached. Unfortunately, torque-related stresses on the wind turbine gearbox components, the wind's inherent speed fluctuations and the frequent onslaught of rain, snow, hail, dust and other elements in general, have caused many gearboxes to break down. These breakdowns have caused transmission fluid to leak out and pollute the surrounding soil and water where the wind turbines were located.

Finally, there is some concern about the impact of wind turbines on wildlife, especially birds. The impact of wind energy on birds, which can fly into turbines directly, or indirectly have their habitats degraded by wind development, is complex with various studies contradicting one another. However, recent studies have shown that wind turbines may kill over 500,000 birds just in the United States.

Therefore, it would be desirable to provide an apparatus and method that overcome the above problems.

### SUMMARY

In accordance with one embodiment, a device to augment gas flow so an exit gas flow will have a higher exit velocity than an inlet gas flow is disclosed. The device has an inner structure having a first open end and a second open end. The inner structure is hollow. The inner structure tapers down from both the first open end and the second open end to a neck area. At least one opening is formed in the neck area. An outer structure has a first open end and a second open end. The outer structure is hollow. A diameter of the first open end of the outer structure and the second open end of the outer structure are approximately equal and allow the inner structure to slide within the outer structure. At least one outer structure opening is formed in a central area of the outer structure. A housing is attached to the at least one outer structure directing gas flow from a propulsion device within the housing into the device.

In accordance with one embodiment, a device to augment gas flow so an exit gas flow will have a higher exit velocity than an inlet gas flow is disclosed. The device has an inner structure having a first open end and a second open end. The inner structure is hollow. The inner structure tapers down from both the first open end and the second open end to a neck area. At least one opening is formed in the neck area. An outer structure has a first open end and a second open end. The outer structure is hollow. A diameter of the first open end of the outer structure and the second open end of the outer structure are approximately equal and allow the inner structure to slide within the outer structure. At least one outer structure opening is formed in a central area of the outer structure. A turbine generator is positioned within an interior of the inner structure.

In accordance with one embodiment, a system to augment gas flow so an exit gas flow will have a higher exit velocity than an inlet gas flow has a plurality of gas flow augmenting devices attached together wherein an exit of a proceeding gas flow augmenting device is attached to an entry of a succeeding gas flow augmenting device. Each of the plurality of gas flow augmenting devices has an inner structure having a first open end and a second open end. The inner structure is hollow. The inner structure tapers down from both the first open end and the second open end to a neck area. At least one opening is formed in the neck area. An outer structure has a first open end and a second open end. The outer structure is hollow. A diameter of the first open end of the outer structure and the second open end of the outer structure are approximately equal and allow the inner structure to slide within the outer structure. At least one outer structure opening is formed in a central area of the outer structure. A turbine generator is positioned within an interior of the inner structure.

### BRIEF DESCRIPTION OF THE DRAWINGS

The present application is further detailed with respect to the following drawings. These figures are not intended to limit the scope of the present application but rather illustrate certain attributes thereof.

FIG. 1 is a cross-sectional side view of an exemplary embodiment of a device for augmenting gas flow in accordance with one aspect of the present application;

FIG. 2 is an exploded side view of an exemplary embodiment of a device for augmenting gas flow in accordance with one aspect of the present application;

FIG. 3 is a cross-sectional side view of an exemplary embodiment of a device for augmenting gas flow having a propellor in accordance with one aspect of the present application.

FIG. 4 is a cross-sectional side view of an exemplary embodiment of a device for augmenting gas flow having a turbine generator in accordance with one aspect of the present application;

FIG. 5 is a cross-sectional side view of an exemplary embodiment of a system for augmenting gas flow in accordance with one aspect of the present application; and

FIG. 6 is a cross-sectional side view of an exemplary embodiment of a system for augmenting gas flow each unit having a turbine generator and connected together in a circular loop in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to a device and method for augmenting gas flow. The device and method allow gas flow to enter the device and compress in a neck region of the device. Outside gas may be drawn into the device through vent holes. As the gas flow exits the neck region, the gas flow expands to an outlet with an increased exit velocity and power output.

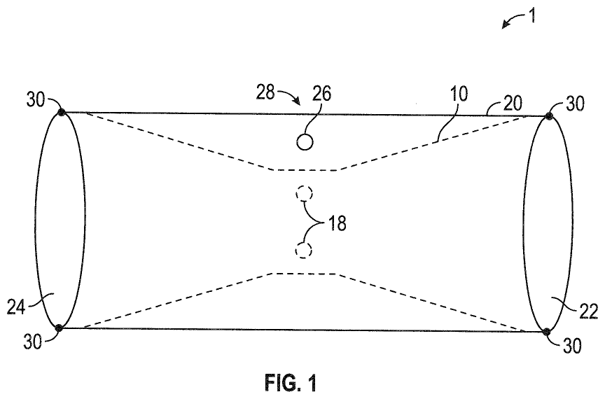

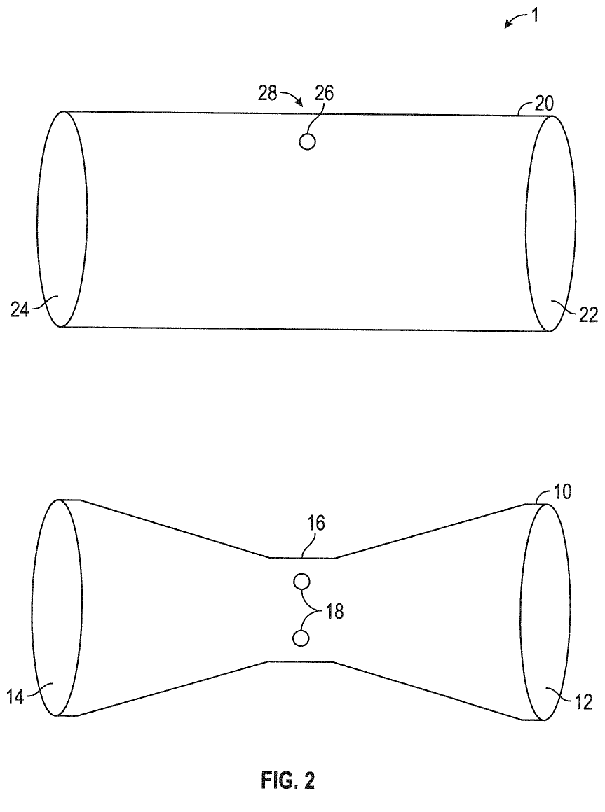

Referring to FIGS. 1 and 2, a device 1 for augmenting gas flow may be seen. The device 1 may be used to increase the exit velocity of a gas flow into the device and hence power factor by three to six-fold or more. The device 1 has an inner tube 10. The inner tube 10 may be hollow and has a first opening 12 and a second opening 14. In the present embodiment, the diameter of the first opening 12 and the second opening 14 may be approximately the same size. The inner tube 10 may have a length that is no less than twice the diameter of the first opening 12.

The inner tube 10 may taper down from both the first opening 12 and the second opening 14 to a neck area 16. In accordance with one embodiment, the taper on both ends of the inner tube may mirror one another and may have approximately the same slope. However, while the inner tube 10 in FIG. 1 is shown as being symmetrical, it is just shown as an example and should not be seen in a limiting manner.

The neck area 16 may be a non-tapered tubular section located in a middle area of the inner tube 10 between the first opening 12 and the second opening 14. In the present embodiment, the neck area 16 may flatten out such that a top area 16A of the neck 16 may be parallel to a bottom area 16B of the neck 16.

The neck area 16 may have a diameter smaller than the first opening 12 and the second opening 14 due to the taper. In accordance with one embodiment, the diameter of the neck area 16 may not exceed half the diameter of the first opening 12. These ratios guarantee the optimal compression that cause a vortex when the gas expands from the neck area 16.

In the embodiment shown, the inner tube 10 with the neck area 16 are shown as being tubular in shape. However, the inner tube 10 and the neck area 16 may take on different geometrical configurations. For example, inner tube 10 and the neck area 16 may be elliptical, trapezoidal having rounded/curved corners, or the like. The aforementioned are given as examples and should not be seen in a limiting manner. The interior of the inner tube 10 should minimize edges to allow less resistant to gas flowing therethrough. Thus, if the inner tube 10 and the neck area 16 are trapezoidal, the corners should have rounded/curved corners thereby minimized the edges.

One or more openings 18 may be formed in the neck area 16. The openings 18 may be spaced around a perimeter of the neck area 16. The openings 18 may be used to draw outside gas into an interior of the inner tube 10. In accordance with one embodiment, the openings may be equally spaced around the perimeter of the neck area 16.

The device 1 may have an outer tube 20. The outer tube 20 may be hollow and has a first opening 22 and a second opening 24. In the embodiment shown in FIG. 1, the diameter of the first opening 22 and the second opening 24 may be approximately the same size. The diameter of the first opening 22 and the second opening 24 may shaped and sized to allow the inner tube 10 to slide tightly within the outer tube 20 so that there is no gap between the first opening 12 of the inner tube 10 and the first opening 22 of the outer tube 20 and between the second opening 14 of the inner tube 10 and the second opening 24 of the outer tube 20. Connectors 30 may be used to attached an edge of the first opening 12 of the inner tube 10 to an edge of the first opening 22 of the outer tube 20 and to attached an edge of the second opening 14 of the inner tube 10 to an edge of the second opening 24 of the outer tube 20. The connectors 30 may be used to ensure there is no gap between the first opening 12 of the inner tube 10 and the first opening 22 of the outer tube 20 and between the second opening 14 of the inner tube 10 and the second opening 24 of the outer tube 20. While the FIGs. show the outer tube 20 being approximately a same length as the inner tube 10, this is shown as an example and should not be seen in a limiting manner. The outer tube 20 may be longer than the inner tube 10, with the inner tube being slid within an interior of the outer tube 20. In this embodiment, the diameter of the first opening 22 and the second opening 24 may shaped and sized to allow the inner tube 10 to slide tightly within the outer tube 20 so that there is no gap between the first opening 12 of the inner tube 10 and the interior of the outer tube 20 and between the second opening 14 of the inner tube 10 and the interior of the outer tube 20.

In the embodiment shown in the FIGs., the outer tube 20 is shown as being tubular in shape. However, the outer tube 20 may take on different geometrical configurations. For example, outer tube 20 may be elliptical, trapezoidal having rounded/curved corners, or the like. The aforementioned are given as examples and should not be seen in a limiting manner.

One or more openings 26 may be formed in a central area 28 of the outer tube 20. The central area 28 may located proximate the neck area 16 of the inner tube 10 when the inner tube 10 is positioned within the outer tube 20.

In operation, gas flow may enter the device 1 through the first opening 12 of the inner tube 10. The inner tube 10 compresses incident gas flow into the neck area 16. Based on the Venturi effect, the velocity of the gas flow will increase as it passes through the neck area 16, while the static pressure will decrease. Thus, any gain in kinetic energy the gas flow may gain due to the increase in velocity is balanced by a drop-in pressure. The decrease in pressure in the inside of the inner tube 10 may create an imbalance with the ambient gas pressure. Based on the imbalance, the openings 18 formed in the neck area 16 draws fresh gas from the atmosphere into the device 1 via the openings 26 formed in the outer tube 20.

Based on the Coanda effect, the gas flow will tend to stay attached to a convex surface. However, by manipulating the curvature of the gas flow passage, more gas mass can be brought into the gas stream. Experimental data indicated that the exit gas velocity is up almost 250% compared to the inlet gas velocity. The increase in the exit gas velocity allows the exit gas kinetic energy to increase by almost 6 times that of the incident gas.

As may be seen in the chart below, the inlet gas velocity and the exit gas velocity of the device 1 may be seen for various different diameter sizes for the neck area 16. In the test shown below, the diameter of the first opening 12 of the inner tube 10, the first opening 22 of the outer tube 20, the second opening 14 of the inner tube 10 and the second opening 24 of the outer tube 20 are all approximately 6″.

| Neck Area Diameter | Inlet Gas Velocity (MPH) | Exit Gas Velocity (MPH) |
|---|---|---|
| 3″ | 38.6 | 66.7 |
| 2½″ | 38.6 | 95.3 |
| 1½″ | 38.0 | 94.6 |

The device 1 may be used to replace existing wind turbines and some of the problems associated with them. The device 1 could be coupled to existing towers, mast or buildings individually or in arrays. Smaller fans may be installed in the outer tube 20 proximate the second opening 24 to capture the kinetic energy exiting from the device 1 and to rotate a turbine for the generation of electricity.

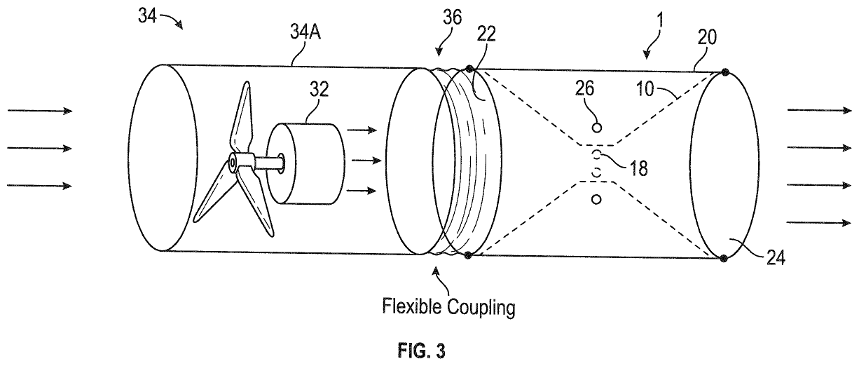

The device 1 may be used in push-type propulsion. Referring to FIG. 3, a propulsion device 32 may be positioned in front of the device 1. The propulsion device 32 may be a jet engine, a propeller engine or other type of device. The propulsion device 32 may be placed within a housing 34. In accordance with one embodiment, the housing 34 may be a cylindrical housing 34A. The cylindrical housing 34A may be attached to the device 1. In accordance with one embodiment, the cylindrical housing 34A may be coupled to the outer tube 20 proximate the first opening 22. A flexible coupling 36 may be used to attach the housing 34 to the outer tube 20. The flexible coupling 36 may be a flexible conduit such as a flexible PVC duct or the like.

In operation, the gas flow generated by the propulsion device 32 may exit the cylindrical housing 32A and be directed into the device 1. The exit gas flow may be augmented over 200%. Inert micron-size mass can also be infused into the gas flow via the openings, whereby the thrust is further amplified. This propulsion system is much more efficient than open-air propellers. And it can be adapted to both fix-wing and roto-wing airships.

The device 1 may further be used in a cyclone type pneumatic grinding machine. A cyclone grinder has a chamber where the particulates are colliding with each other, to accomplish size reduction. Cyclone grinders requires high speed, high volume air flow supply. Thus, the device 1 may be used to aid in providing the high speed, high volume air flow supply.

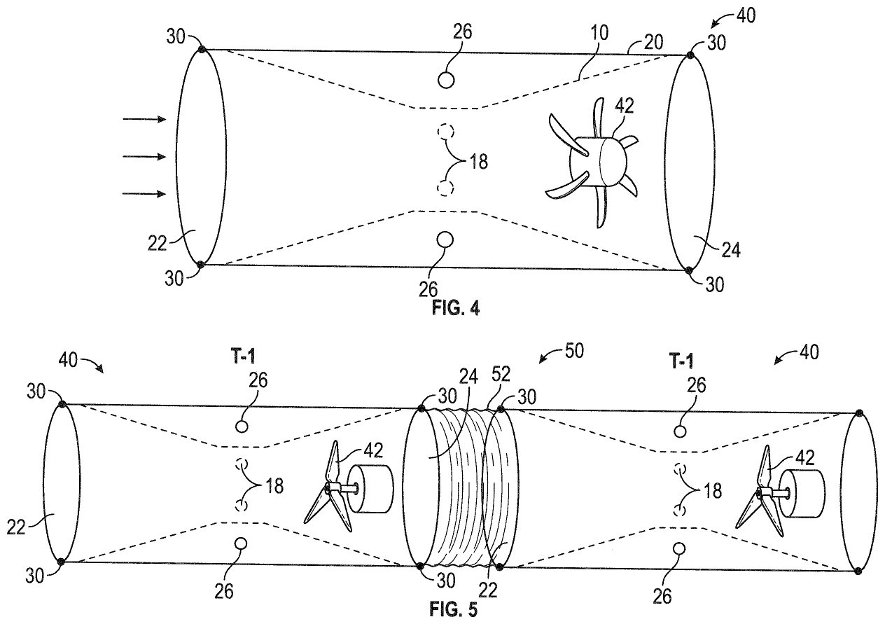

Referring to FIG. 4, a device 40 for augmenting gas flow may be seen. The device 40 may be used to increase the exit velocity of gas flow into the device 40 and hence power factor by three to six-fold or more. The device 40 has an inner tube 10. The inner tube 10 may be hollow and has a first opening 12 and a second opening 14. In the present embodiment, the diameter of the first opening 12 and the second opening 14 may be approximately the same size. The inner tube 10 may have a length that is no less than twice the diameter of the first opening 12.

The inner tube 10 may taper down from both the first opening 12 and the second opening 14 to a neck area 16. In accordance with one embodiment, the taper on both ends of the inner tube may mirror one another and may have approximately the same slope. However, while the inner tube 10 in FIG. 3 is shown as being symmetrical, it is just shown as an example and should not be seen in a limiting manner.

The neck area 16 may be a non-tapered tubular section located in a middle area of the inner tube 10 between the first opening 12 and the second opening 14. In the present embodiment, the neck area 16 may flatten out such that a top area 16A of the neck 16 may be parallel to a bottom area 16B of the neck 16.

The neck area 16 may have a diameter smaller than the first opening 12 and the second opening 14 due to the taper. In accordance with one embodiment, the diameter of the neck area 16 may not exceed half the diameter of the first opening 12. These ratios guarantee the optimal compression that cause a vortex when the gas expands from the neck area 16.

In the embodiment shown, the inner tube 10 with the neck area 16 are shown as being tubular in shape. However, the inner tube 10 and the neck area 16 may take on different geometrical configurations. For example, inner tube 10 and the neck area 16 may be elliptical, trapezoidal having rounded/curved corners, or the like. The aforementioned are given as examples and should not be seen in a limiting manner. The interior of the inner tube 10 should minimize edges to allow less resistant to gas flowing therethrough. Thus, if the inner tube 10 and the neck area 16 are trapezoidal, the corners should have rounded/curved corners thereby minimized the edges.

One or more openings 18 may be formed in the neck area 16. The openings 18 may be spaced around a perimeter of the neck area 16. The openings 18 may be used to draw outside gas into an interior of the inner tube 10. In accordance with one embodiment, the openings may be equally spaced around the perimeter of the neck area 16.

The device 40 may have an outer tube 20. The outer tube 20 may be hollow and has a first opening 22 and a second opening 24. In the embodiment shown in FIG. 3, the diameter of the first opening 22 and the second opening 24 may be approximately the same size. The diameter of the first opening 22 and the second opening 24 may shaped and sized to allow the inner tube 10 to slide tightly within the outer tube 20 so that there is no gap between the first opening 12 of the inner tube 10 and the first opening 22 of the outer tube 20 and between the second opening 14 of the inner tube 10 and the second opening 24 of the outer tube 20. Connectors 30 may be used to attached an edge of the first opening 12 of the inner tube 10 to an edge of the first opening 22 of the outer tube 20 and to attached an edge of the second opening 14 of the inner tube 10 to an edge of the second opening 24 of the outer tube 20. The connectors 30 may be used to ensure there is no gap between the first opening 12 of the inner tube 10 and the first opening 22 of the outer tube 20 and between the second opening 14 of the inner tube 10 and the second opening 24 of the outer tube 20. While FIG. 4. shows the outer tube 20 being approximately a same length as the inner tube 10, this is shown as an example and should not be seen in a limiting manner. The outer tube 20 may be longer than the inner tube 10, with the inner tube being slid within an interior of the outer tube 20. In this embodiment, the diameter of the first opening 22 and the second opening 24 may shaped and sized to allow the inner tube 10 to slide tightly within the outer tube 20 so that there is no gap between the first opening 12 of the inner tube 10 and the interior of the outer tube 20 and between the second opening 14 of the inner tube 10 and the interior of the outer tube 20.

In the embodiment shown in FIG. 4, the outer tube 20 is shown as being tubular in shape. However, the outer tube 20 may take on different geometrical configurations. For example, outer tube 20 may be elliptical, trapezoidal having rounded/curved corners, or the like. The aforementioned are given as examples and should not be seen in a limiting manner.

One or more openings 26 may be formed in a central area 28 of the outer tube 20. The central area 28 may located proximate the neck area 16 of the inner tube 10 when the inner tube 10 is positioned within the outer tube 20.

A turbine generator 42 may be positioned within the device 40. The turbine generator 42 may be placed in an interior of the inner tube 10. In accordance with one embodiment, the turbine generator 42 may be positioned towards the second opening 24.

In operation, gas flow may enter the device 40 through the first opening 12 of the inner tube 10. The inner tube 10 compresses incident gas flow into the neck area 16. Based on the Venturi effect, the velocity of the gas flow will increase as it passes through the neck area 16, while the static pressure will decrease. Thus, any gain in kinetic energy the gas flow may gain due to the increase in velocity is balanced by a drop-in pressure. The decrease in pressure in the inside of the inner tube 10 may create an imbalance with the ambient air pressure. Based on the imbalance, the openings 18 formed in the neck area 16 draw fresh gas from the atmosphere into the device 1 via the openings 26 formed in the outer tube 20.

Based on the Coanda effect, the gas flow will tend to stay attached to a convex surface. However, by manipulating the curvature of the gas flow passage, more gas mass can be brought into the gas stream. Experimental data indicated that the exit gas velocity is up almost 250% compared to the inlet gas velocity. The increase in the exit gas velocity allows the exit gas kinetic energy to increase by almost 6 times that of the incident gas. The increase in the exit gas velocity may cause the rotation of the turbine generator 42 thereby generating electricity.

The device 40 may be used to expand gas mass flow to any compressible gas. For example, the device 40 may be used to recover and augment exhaust gas from internal combustion engine or turbine engine's wasted thermal energy for electricity generation or propulsion of aerial vehicles.

Referring now to FIG. 5, a system 50 may be seen which connects multiple devices 40 together. The devices 40 may be attached together in series such that the second opening 24 of a preceding device 40 is attached to the first opening 22 of an adjacent succeeding device 40. A flexible conduit 52 may be used to attach the second opening 24 of the preceding device 40 to the first opening 22 of the adjacent succeeding device 40. By aligning and attaching multiple devices 40 together, the system 50 may generate additional electricity.

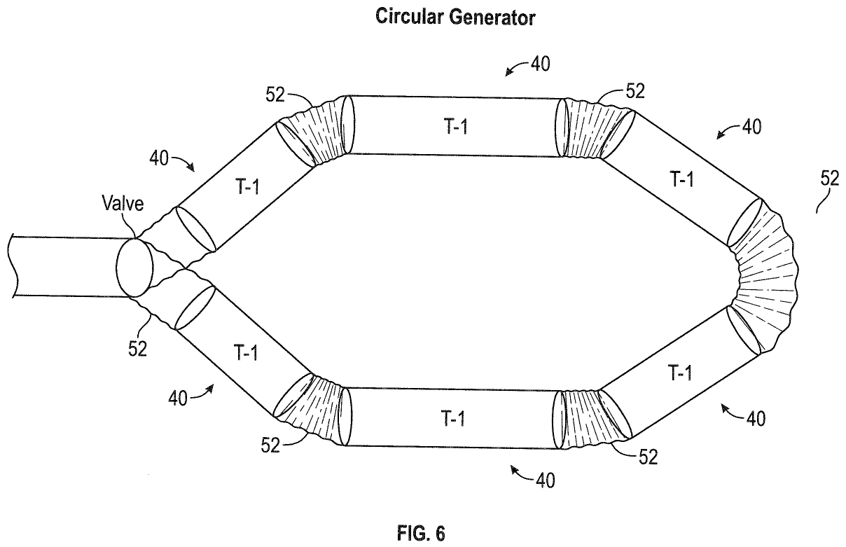

Referring to FIG. 6, a system 60 may be seen which connects multiple devices 40 together. In this embodiment, the devices 40 may be attached together in a circular manner. The devices 40 may be attached together in series in a circular configuration such that the second opening 24 of a preceding device 40 is attached to the first opening 22 of an adjacent succeeding device 40. A flexible conduit 52 may be used to attach the second opening 24 of the preceding device 40 to the first opening 22 of the adjacent succeeding device 40. By aligning and attaching multiple devices 40 together gas may flow through the system 50 in a circular loop allowing the system 50 may generate additional electricity.

A connector 62 may be used to connect the first and last of the devices 40. Thus, the connector 62 may be connected to the first opening 22 of the first device 40 and to the second opening 24 of the last device 40. In accordance with one embodiment, the connector 62 is a “Y” connector. The connector 62 may be used to select between fresh gas input and/or recycled discharge gas to run through the system 60. If fresh gas is used as the input gas, the connector 62 may be designed to allow the gas to exit the system 60 once it runs through the system 60.

While embodiments of the disclosure have been described in terms of various specific embodiments, those skilled in the art will recognize that the embodiments of the disclosure may be practiced with modifications within the spirit and scope of the claims.

What is claimed is:

1. A device to augment gas flow so an exit gas flow will have a higher exit velocity than an inlet gas flow comprising:
an inner structure having a first open end and a second open end, the inner structure being hollow, wherein the inner structure tapers down from both the first open end and the second open end to a neck area;
at least one opening formed in the neck area;
an outer structure having a first open end and a second open end, the outer structure being hollow, wherein a diameter of the first open end of the outer structure and the second open end of the outer structure are approximately equal, wherein the diameter of the first open end of the outer structure and the second open end of the outer structure allow the inner structure to slide within the outer structure;
at least one outer structure opening formed in a central area of the outer structure; and
a housing attached to the at least one outer structure directing gas flow from a propulsion device within the housing into the device.

2. The device of claim 1, wherein a diameter of the first opening and the second opening are approximately equal in size.

3. The device of claim 1, wherein the inner structure has a length that is at least twice a diameter of the first opening.

4. The device of claim 1, wherein the tapers from both the first open end and the second open end to the neck area mirror one another and have approximately same slopes.

5. The device of claim 1, wherein the neck area is a non-tapered area and opposing surfaces of the neck area are parallel.

6. The device of claim 1, comprising a plurality of openings formed in the neck area, wherein the openings are spaced around a perimeter of the neck area.

7. The device of claim 1, wherein the outer structure is a tubular structure.

8. The device of claim 7, wherein the housing is a tubular structure.

9. The device of claim 1, comprising a flexible coupling attaching the at least one outer structure to the housing.

10. A device to augment gas flow so an exit gas flow will have a higher exit velocity than an inlet gas flow comprising:
an inner structure having a first open end and a second open end, the inner structure being hollow, wherein the inner structure tapers down from both the first open end and the second open end to a neck area;
at least one opening formed in the neck area;
an outer structure having a first open end and a second open end, the outer structure being hollow, wherein a diameter of the first open end of the outer structure and the second open end of the outer structure are approximately equal, wherein the diameter of the first open end of the outer structure and the second open end of the outer structure allow the inner structure to slide within the outer structure;
at least one outer structure opening formed in a central area of the outer structure; and
a turbine generator positioned within an interior of the inner structure.

11. The device of claim 10, wherein a diameter of the first opening and the second opening are approximately equal in size.

12. The device of claim 10, wherein the inner structure has a length that is at least twice a diameter of the first opening.

13. The device of claim 10, wherein the tapers from both the first open end and the second open end to the neck area mirror one another and have approximately same slopes.

14. The device of claim 10, wherein the neck area is a non-tapered area and opposing surfaces of the neck area are parallel.

15. The device of claim 10, comprising a plurality of openings formed in the neck area, wherein the openings are spaced around a perimeter of the neck area.

16. The device of claim 10, wherein the outer structure is a tubular structure.

17. A system to augment gas flow so an exit gas flow will have a higher exit velocity than an inlet gas flow comprising:
a plurality of gas flow augmenting devices attached together wherein an exit of a proceeding gas flow augmenting device is attached to an entry of a succeeding gas flow augmenting device, wherein each of the plurality of gas flow augmenting devices comprises:
an inner structure having a first open end and a second open end, the inner structure being hollow, wherein the inner structure tapers down from both the first open end and the second open end to a neck area;
at least one opening formed in the neck area;
an outer structure having a first open end and a second open end, the outer structure being hollow, wherein a diameter of the first open end of the outer structure and the second open end of the outer structure are approximately equal, wherein the diameter of the first open end of the outer structure and the second open end of the outer structure allow the inner structure to slide within the outer structure;
at least one outer structure opening formed in a central area of the outer structure; and
a turbine generator positioned within an interior of the inner structure.

18. The system of claim 17, wherein the plurality of gas flow augmenting devices are attached serially together.

19. The device of claim 17, wherein the plurality of gas flow augmenting devices are attached serially together in a circular configuration.

20. The device of claim 19, comprising a “Y” valve coupled to an entry of a first of the plurality of gas flow augmenting devices and to an exit of a last of the plurality of gas flow augmenting devices.
